(19) United States
(12) Patent Application Publication
(10) Pub. No.: US 2005/0021462 A1
(43) Pub. Date: Jan. 27, 2005

(54) Method and system to process a billing failure in a network-based commerce facility

(76) Inventors: Don Teague, San Jose, CA (US); Joe Lynam, Cupertino, CA (US); Greg Calcagno, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/658,014

(22) Filed: Sep. 8, 2003

Related U.S. Application Data
(63) Continuation-in-part of application No. 10/624,837, filed on Jul. 21, 2003.

(51) Int. Cl. G06F 17/60

(52) U.S. Cl. 705/40

(57) ABSTRACT

A method and system is provided to process a billing failure in a network-based commerce facility. The method may include receiving a billing failure indicator from a billing facility, the billing failure indicator being associated with a transaction processing method utilized by a user or customer when conducting a user transaction. The method may then automatically, without human intervention, identify at least one alternative transaction processing method that is valid for the user. The at least one alternative transaction processing method is then communicated to an associated billing facility for billing. In one embodiment, the method includes retrieving the at least one alternative transaction processing method from a database of predetermined transaction processing methods associated with the user.

### CROSS REFERENCE TO RELATED APPLICATION

The application is a continuation-in-part of U.S. patent application Ser. No. 10/624,837 filed on Jul. 21, 2003, entitled Method and System To Process A Transaction In A Network-Based Commerce Facility.

### FIELD OF THE INVENTION

The present invention relates generally to the field of financial transactions and, more specifically, to method and system to process a billing failure in a network-based commerce facility.

### BACKGROUND TO THE INVENTION

Various different financial instruments may be used to purchase products (e.g., goods and/or services) via a network-based commerce facility (e.g., the Internet). Circumstances may, however, arise where a purchaser chooses to conclude a purchase transaction using a financial instrument (e.g., a telephone bill, bank account or the like) that fails even though the transaction was initially validated. In certain circumstances, once the transaction has been concluded the products may be provided to the purchaser (e.g., digital content may be streamed, physical goods may be shipped, or the like). Although the merchant or transaction processing facility may immediately submit the transaction to the appropriate billing facility, a billing failure may occur several hours or even a few days later. Thus, it will be appreciated that a billing failure (e.g., an indication that the transaction cannot be billed to the financial instrument) may occur some time after the initial transaction is approved and/or concluded.

Although the initial purchase transaction via the network-based commerce facility may be fully automated without human intervention (except for the purchaser), when a financial instrument or payment method fails upon presentment of a billing transaction to an associated facility for billing (e.g., bank account details to an ACH), manual intervention by a human or person is required. Such a person may personally contact the purchaser (e.g. via a telephone call or an email) and advise the user of the billing failure and attempt to obtain the required funds from the purchaser. In addition or instead, the person may arrange for the financial instrument to be presented again to the associated facility (e.g., the same transaction may be re-submitted to an ACH) with the hope of obtaining payment for the transaction.

### SUMMARY OF THE INVENTION

According to one aspect of the present invention, there is provided a method to process a billing failure in a network-based commerce facility, the method including:
receiving a billing failure indicator from a billing facility, the billing failure indicator being associated with a transaction processing method utilized by a user when conducting a user transaction;
automatically without human intervention identifying at least one alternative transaction processing method that is valid for the user; and
automatically communicating the at least one alternative transaction processing method to an associated billing facility for billing.

The method may include retrieving the at least one alternative transaction processing method (e.g., a payment method) from a database of predetermined transaction processing methods (e.g., a database of predetermined payment methods) associated with the user and/or merchant. In one embodiment, identifying the at least one alternative transaction processing method may include generating a reliability score value utilizing user information, and selecting a transaction processing method that includes favorable reliability score.

The at least one alternative transaction processing method may be one of a plurality of transaction processing methods presented to the user when the user initially concluded the user transaction. In one embodiment the method includes identifying the at least one alternative transaction processing method from user information associated with the user; and updating the user information in response to the billing failure for use with future user transactions.

The plurality of alternative transaction processing methods may include at least one of a credit card option, a phone bill option, an ACH option, a payment by check option, a direct bill option, and a prepayment option. It will, however, be appreciated that billing failures associated with any transaction processing method may be processed using the method in accordance with the invention.

Identifying the at least one alternative transaction processing method may include identifying a transaction processing method utilizing at least one of vendor criteria, user criteria, type of purchase event criteria, and purchaser payment psychology.

In one embodiment, billing failure data is communicated to a merchant with whom the user transaction was conducted, the billing failure data identifying the alternative transaction processing method. An electronic communication may be made to the user to indicate that the transaction has been billed using the alternative transaction processing method.

When the alternative transaction processing method is a direct bill (e.g., a paper bill or invoice), the method may include mailing the direct bill to an address that is generated using information associated with the first transaction processing method. The first transaction processing method and the at least one alternative transaction processing method may be transaction processing methods that are pre-authorized by the user.

The invention extends to a system to process a billing failure in a network-based commerce facility.

The invention also extends to a machine-readable medium embodying a sequence of instructions for executing any one or more of the methodologies described herein.

Other features of the present invention will be apparent from the accompanying drawings and from the detailed description that follows.

### BRIEF DESCRIPTION OF THE DRAWINGS

The present invention is illustrated by way of example, and not limitation, in the figures of the accompanying drawings, and in which:

FIG. 1 is a schematic block diagram of a prior art system for processing a transaction concluded via the Internet.

FIG. 2 is a schematic representation of a system, according to one embodiment of the present invention, for processing a transaction via a network-based commerce facility.

FIG. 3 is a schematic block diagram of transaction processing equipment according to one embodiment of the present invention.

FIG. 4 is a schematic representation of a payment option rules engine, according to one embodiment of the present invention.

FIG. 5 is a schematic diagram of the interaction between various participants in the transaction processing system according to one embodiment of the present invention.

FIGS. 6 and 7 are schematic operational flow diagrams of two exemplary methods, according to one embodiment of the present invention, to process a transaction in a network-based commerce facility to facilitate presentment of the approved payment method options.

FIG. 8 shows an exemplary entry interface for obtaining user or customer information.

FIG. 9 shows an exemplary selection interface whereby a user may select a payment method.

FIG. 10 shows a schematic functional diagram of a system, in accordance with the invention, to process a billing failure in a network-based commerce facility.

FIG. 11 is a schematic representation of an exemplary billing failure engine, according to one embodiment of the present invention.

FIG. 12 is a schematic operational flow diagram of an exemplary method, according to one embodiment of the present invention, to process a billing failure in a network-based commerce facility.

FIG. 13 is a diagrammatic representation of a machine in the exemplary form of a computer system within which a set of instructions, for causing the machine to perform any one of the methodologies discussed herein, may be executed.

### DETAILED DESCRIPTION

In a transaction between a purchaser (e.g., a consumer or user) and a vendor (e.g., a merchant), if the purchaser wishes to pay using a credit card, the merchant typically obtains details of the credit card from the purchaser and verifies the transaction via a credit card gateway prior to finalizing the transaction. Certain vendors, in order to facilitate transactions with purchasers who do not have credit cards, may offer the option of having the charges related to a particular transaction applied to another account (e.g., a utility account) of the purchaser. It will however be appreciated that some purchaser verification may be associated with any payment option. For example, if the purchaser wishes to pay by applying a charge to a telephone bill, it is desirable to provide a method whereby the merchant can verify the transaction and the identity of the purchaser in control of the payment instrument (telephone bill). However, even if the financial instrument chosen by the purchaser is verified, this need not guarantee payment by the purchaser when the instrument is submitted to a billing facility (e.g., telephone company).

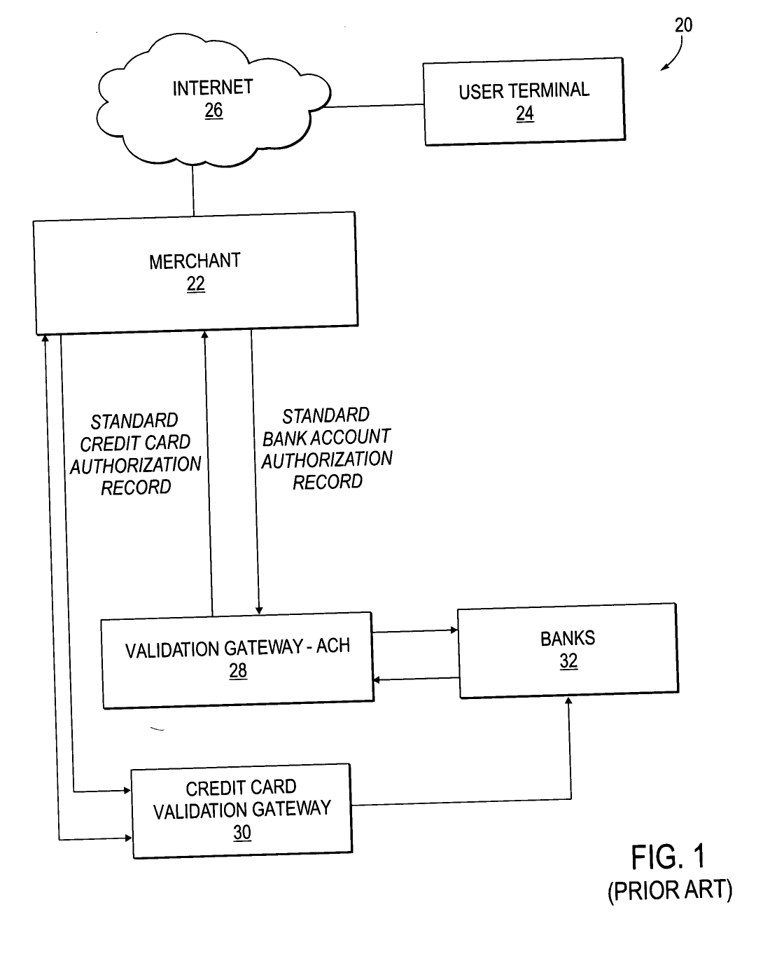

Referring to FIG. 1, reference numeral 20 generally indicates a prior art system for processing a transaction between a merchant 22 and a user or purchaser using a user terminal 24 (typically a personal computer (PC) or the like) via the Internet 26. When the user purchases goods and/or services (cumulatively referred to as products) via the Internet 26, the user is usually prompted to enter credit card or bank account details into the user terminal 24, which are then communicated via the Internet 26 to the merchant 22.

Dependent upon the mode of payment selected, the merchant 22 then communicates an authorization record, as commonly used in the industry, to an appropriate validation gateway 28, 30 or a telephone number validation application program interface (API) 34. Usually, the merchant 22 first validates or checks whether or not the transaction can be processed by communicating with the validation gateways 28,30 or the telephone number validation API 34 and, if validated, the merchant 22 may subsequently obtain payment for the transaction (bill the transaction) via an appropriate financial institution 32. Thus, the merchant 22 may be required to communicate a standard authorization record in the form of either a standard credit card authorization record or a standard bank account authorization record to the validation facilities 30, 28 respectively. Different records are thus communicated to different associated facilities dependent upon the particular payment method selected by the user. In these systems the payment option or options presented to the consumer are independent of the particular consumer.

In accordance with one aspect of the invention, if a purchase verification associated with a payment method fails, the merchant may offer another payment method option to the purchaser. This payment method option may also be subjected to a verification process. In certain embodiments, each time the purchaser selects a new payment method, the merchant may need to go through a predetermined verification process to identify the particular payment method selected by the purchaser as approved or invalid. Thus, in one embodiment of the invention, all of the approved payment method for the purchaser are identified based on the purchaser's personal information obtained from the purchaser or user. The approved payment method options for a particular purchaser thus identified may be stored for that purchaser for use in future transactions. Thus, the payment method options presented to the user or customer may be based on the particular individual.

In accordance with another aspect of the invention, if a billing transaction (e.g., a transaction during which actual billing (e.g., receiving payment) fails, the purchase transaction may be re-billed using an alternative or different payment method. The alternative payment method may be one of the approved payment method options. In certain embodiments, the user may pre-approve the billing to one or more alternative payment or transaction processing methods in the event of a billing failure. In one embodiment, the purchase or user transaction may be re-billed in an automated fashion without human intervention. In another embodiment, the user may be sent an automated request to approve billing the failed billing transaction to the alternative payment or transaction processing method.

In transactions between a purchaser and a vendor (e.g., a merchant) conducted via a network-based commerce facility such as the Internet, a payment method decision for the transaction in one embodiment may be, inter alia, a combination of a purchaser or user payment option preference and, a vendor payment option preference. Merchants concluding transactions with purchasers via the Internet may desire to offer payment methods to purchasers that are most advantageous to the merchant. For example, the merchant may first offer to the purchaser payment options that have a higher rate of collection success followed by those payment options that have a lower rate of collection success. Likewise, a purchaser may prefer certain payment options to other payment options. In order to accommodate the purchaser, the merchant may require verification of financial instrument information in order of the purchaser's preference prior to finalizing the transaction.

In accordance with one aspect of the invention, payment or transaction processing method options can be predictively or dynamically presented to the purchaser based on predetermined business rules that account for various factors including, but not limited to: purchaser payment psychology, available payment methods, a credit score associated with a particular payment method type, a reliability score across payment method types, a vendor payment option presentation and a type of purchase event. The reliability score may be utilized to evaluate the purchaser's “propensity to pay” for like purchases by a particular payment method. The reliability score may thus provide a propensity to pay index.

In the following description, for purposes of explanation, numerous specific details are set forth in order to provide a thorough understanding of the present invention. It will be evident, however, to one skilled in the art that the present invention may be practiced without these specific details.

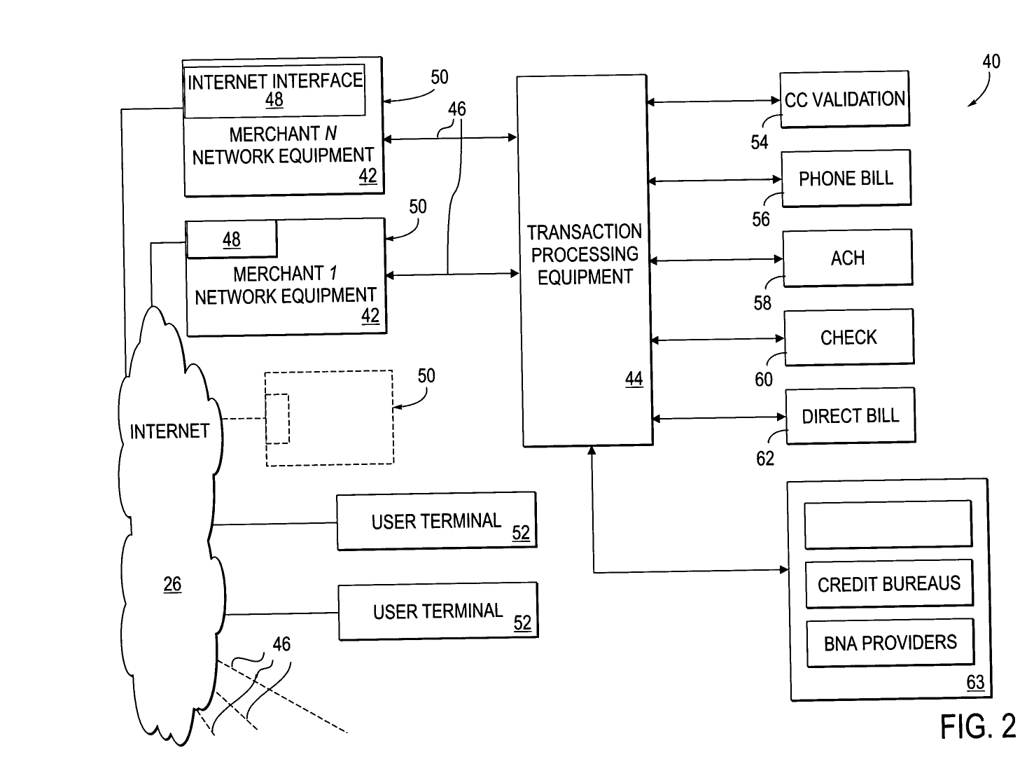

Referring in particular to FIG. 2 of the drawings, reference numeral 40 generally indicates a transaction processing system in accordance with one embodiment of the present invention. The system 40 includes merchant network equipment 42, provided at different remote merchants 50, and transaction processing equipment 44, which is configured to communicate with the merchant network equipment 42 via communication lines 46. In the embodiment depicted in the drawings, the communication lines 46 are shown as dedicated communication lines. However, it is to be appreciated that the communication lines 46 may also form part of any network-based commerce facility such as the Internet 26. The merchant network equipment 42 is connected via an Internet interface 48, which defines a user communication module, to the Internet 26 so that the merchants 50 can, via the merchant network equipment 42, offer goods and/or services (cumulatively referred to as products) for sale to a variety of users via user terminals 52 connected to the Internet 26. The user terminals 52 may be conventional personal computers (PCs) or the like.

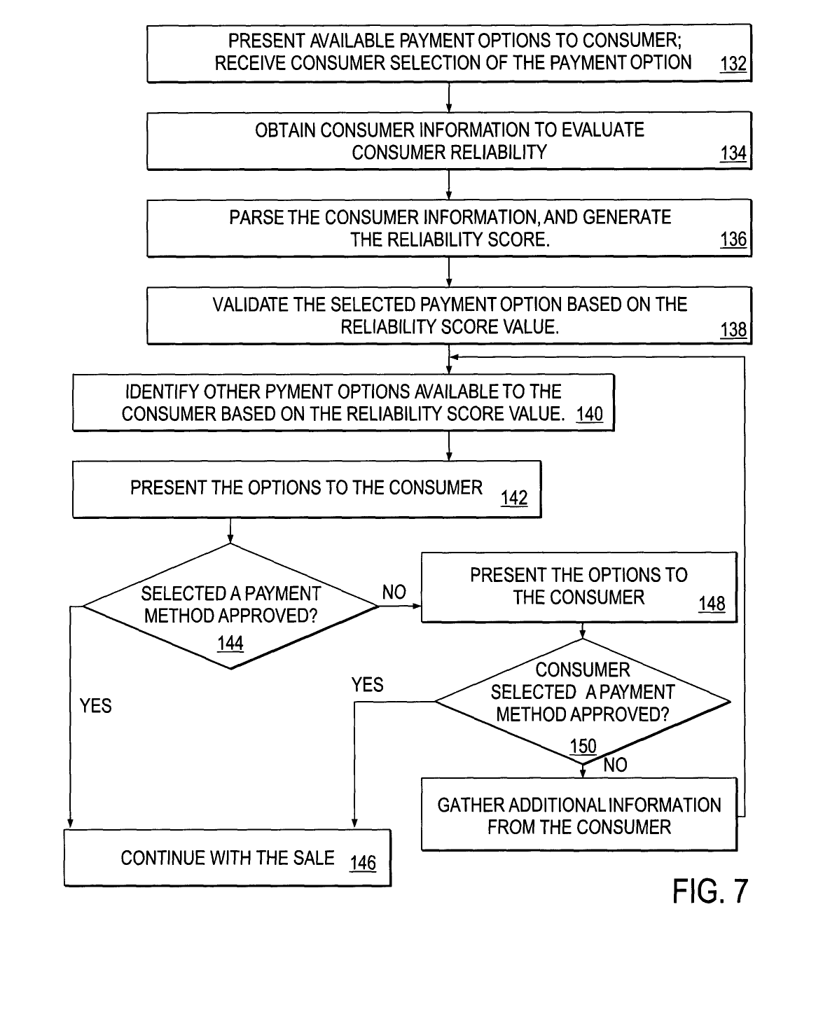

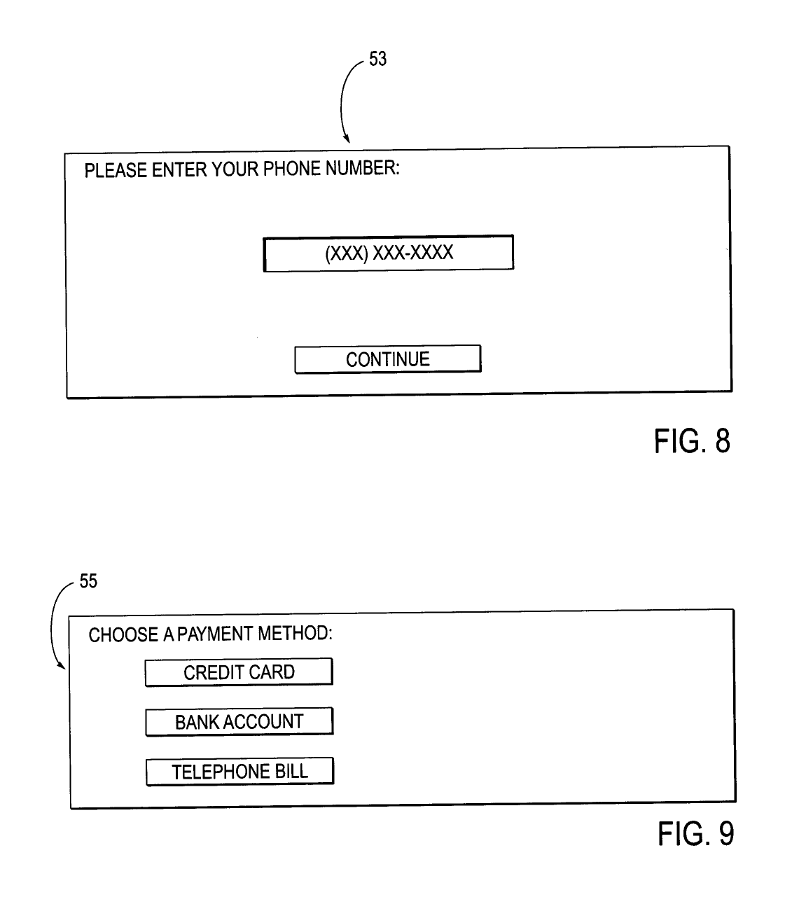

As described in more detail below, a user or purchaser may provide personal information (e.g. a telephone number via a user interface 53 as shown in FIG. 8) and, in response thereto, a plurality of payment method options may be predictively presented (e.g. via a payment option selection interface 55 as shown in FIG. 9). The user may then select a variety of different payment or transaction processing methods to purchase products via the Internet 26. In order to identify the payment method options presented, the merchant network equipment 42 may communicate the user's personal information (or any other identification data) to the transaction processing equipment 44. The information may include, but not be limited to, the user's personal information, such as name, address, and phone number; the information regarding the type of purchase; a merchant's rule set; and an identifier to identify a particular type of payment method selected by the user.

The transaction processing equipment 44 processes the information received from the user to identify one or more approved payment method options among available payment method options to be presented to the user (see the exemplary credit card, bank account and telephone bill options shown in FIG. 9). The available payment method options may be determined utilizing information regarding the payment methods available to the merchant, information regarding the merchant preference, and a purchase type.

If the user information received from the merchant network equipment 42 is sufficient to effectuate validation of a particular payment method, the transaction processing equipment 44 may create a transaction record to be communicated to an appropriate validation and/or billing facility such as credit card validation facility 54, a phone bill validation facility 56, an ACH validation facility 58, a check validation facility 60, or a direct bill validation facility 62. The transaction processing equipment 44 may access other information sources or facilities 63 including, for example, credit bureaus, BNA providers, etc. to perform additional validations.

When the transaction processing equipment 44 receives a response from the relevant facility 54, 56, 58, 60, 62, and 63, one or more payment methods may then be identified as an approved payment method or as an invalid (unapproved) payment method. Once all available payment methods have been identified as approved or invalid, a list of one or more approved payment methods is then communicated from the transaction processing equipment 44 to the merchant 50. Thus, payment method options may be predictively presented to the customer. However, in other embodiments, payment method options may be dynamically presented to the customer. In these circumstances a user may select a particular payment method, and should the particular payment method fail validation, an alternative valid payment method option may be provided to the user.

In the exemplary embodiment depicted in the drawings, the user terminal 52 is shown to communicate indirectly with the transaction processing equipment 44 via the merchant network equipment 42. However, it is to be appreciated that in other embodiments of the invention, the user terminal 52 may communicate directly with the transaction processing equipment 44. Thus, the invention is equally applicable in any network-based commerce facility wherein various components of the facility communicate directly or indirectly with each other.

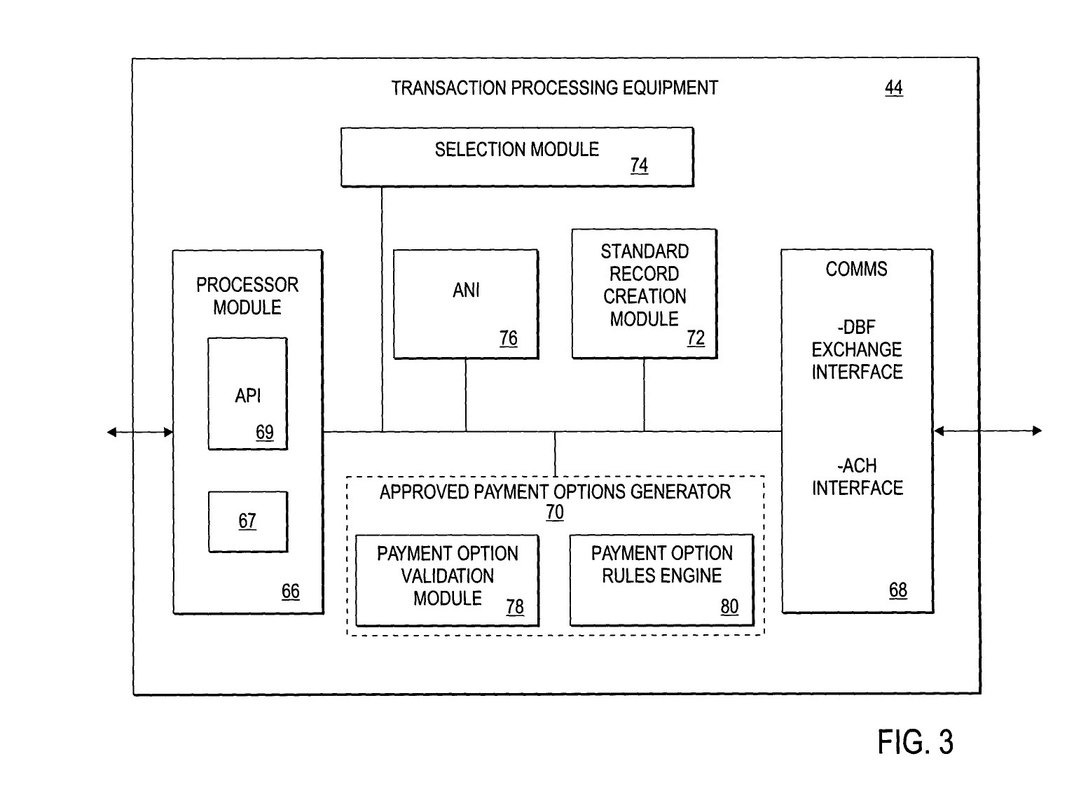

The transaction processing equipment 44 may include the exemplary components illustrated in FIG. 3. For example, the transaction processing equipment 44 may include a processor module 66, a financial service communication module 68, an approved payment method or options generator module 70, a standard record creation module 72, a selection module 74 to present the user with the list of approved payment options, and an automatic line number identification (ANI) module 76.

The approved payment options generator module 70 may include a payment option validation module 78 to identify an available payment method option from a plurality of available payment method options as an approved payment method utilizing, for example, the information received from the merchant network equipment 42 (see FIG. 2). The approved payment option generator module 70 may also include a payment options rules engine 80 to determine a reliability score value for the user (e.g., the user's ‘propensity to pay’ for like purchases, for example, by a particular payment method). The payment options rules engine 80 may be used to determine the reliability score value and the order of available and approved payment options presentation format. It will be appreciated that the reliability score may be determined in different ways and differ from embodiment to embodiment. For example, the reliability score may be influenced by geographic location (e.g., a person's residential address), credit card payment history, Equifax data, birth date and so on.

The payment options rules may account for various factors including, but not limited to: purchaser payment psychology, available payment methods, a credit score by payment method type, a credit score across payment method types, a vendor payment option presentation, and a type of purchase event. Available payment methods may include credit card, bank account, phone bill, invoice, prepayment, cash, or the like.

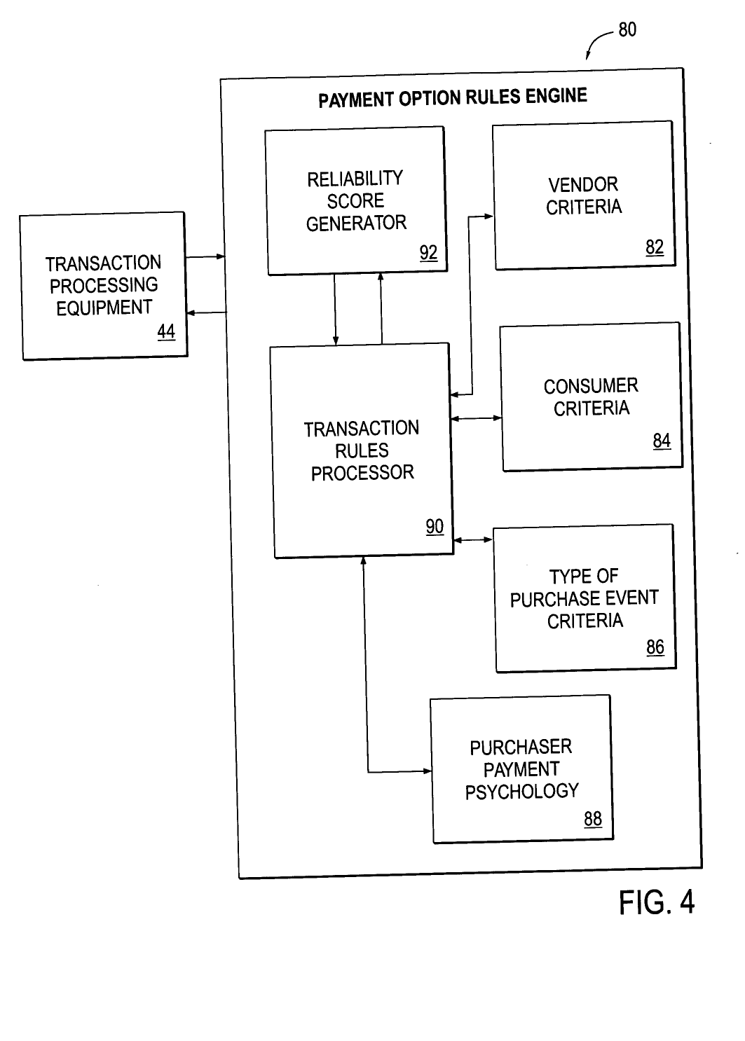

Referring to FIG. 4 of the drawings, reference numeral 80 generally indicates an exemplary embodiment of a payment option rules engine. The payment option rules engine 80, in accordance with the invention, may be utilized to facilitate generation of approved payment methods or options, including but not limited to identifying a payment option presentation format, and determining a reliability score value for a purchaser or consumer. The payment options rules engine 80 may include a vendor criteria module 82, a consumer or user criteria module 84, a type of purchase event criteria module 86, a purchase payment psychology module 88, a transaction rules processor 90, and a reliability score generator 92. In one exemplary embodiment of the present invention, the payment option rules engine 80 may be separate from the transaction processing equipment 44. Accordingly, the transaction processing equipment 44 may then communicate via a communication link with the payment option rules engine 80 to facilitate generation of an approved payment options list. Thus, using one or more of the vendor criteria module 82, the consumer criteria module 84, the type of purchase event criteria module 86, and the purchaser payment psychology module 88, various different payment options may be presented to a customer. It will be appreciated that further modules relating to the purchaser and/or vendor may be included.

Returning to the processor module 66 in FIG. 3, in certain embodiments, it may include a merchant communication module 67 to receive information such as the personal information of the user, the information indicating a type of purchase, the rule set of the merchant, and/or an identifier to identify a particular type of payment method selected by the user. The merchant communication module 67 may also be used to receive and identify a transaction record associated with any one of the account types, which the user may select. The processor module 66 may also include a transaction record API 69, which extracts relevant account data and account type identifiers from the transaction record received from the merchant and, in response thereto, create an appropriate record. The appropriate record may then be communicated via the financial service communication module 68 to a relevant validation facility 54, 56, 58, 60, 62 and 63.

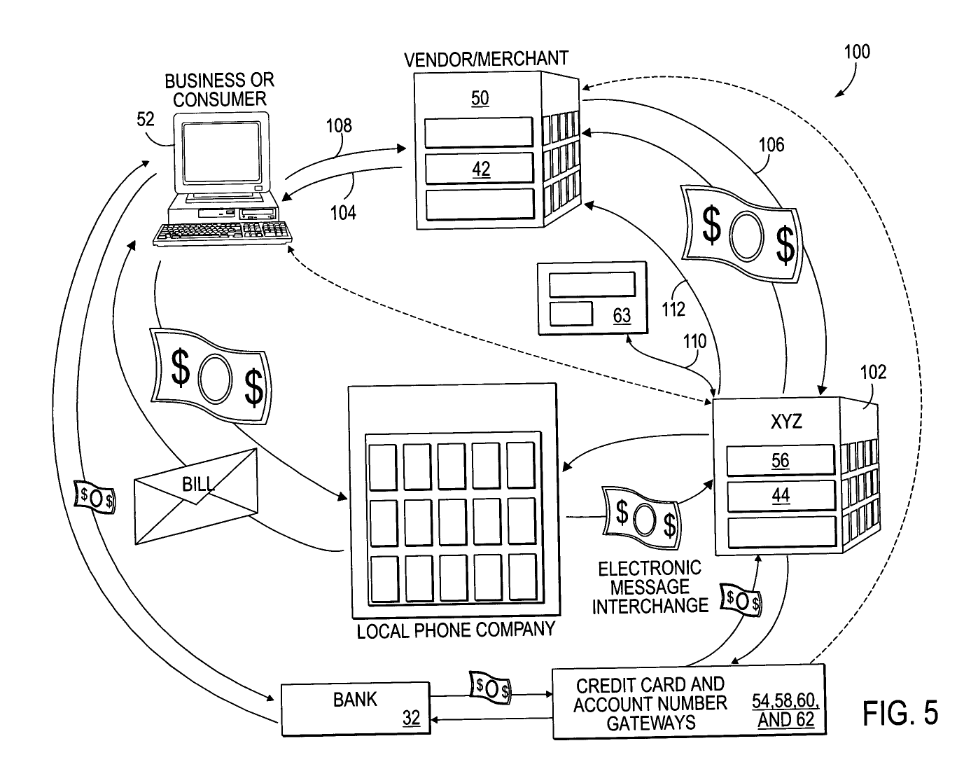

Referring in particular to FIG. 5 of the drawings, reference numeral 100 generally indicates a further embodiment of a transaction processing system in accordance with the invention. The system 100 includes components of the system 40 and, accordingly, the same reference numerals have been used to indicate the same or similar features unless otherwise indicated. In the exemplary system 100, a transaction processing facility 102 provides a one-stop transaction processing service which a vendor or merchant 50 can use to authorize transactions, effect billing for transactions, and provide collection of funds for each transaction billed.

A purchaser or a user typically purchases products from the merchant 50 using a user terminal 52. The merchant 50 using its merchant network equipment 42 communicates data, as shown by arrow 104, to the user terminal 52, which provides the user with an option to purchase products using different payment options or methods.

In one embodiment, prior to finalizing any transaction, the merchant 50 may require validation of a particular account type or payment option, which the user has selected to effect payment. Accordingly, the merchant 50 communicates a validation request, as shown by arrow 106, to the transaction processing facility 102. In an exemplary embodiment, the request is in the form of a transaction record, which may include transaction type identification data as well as merchant identification data.

In one embodiment of the present invention, the merchant 50 may solicit information from a consumer as shown by arrow 108, and, upon receiving the consumer information from the user terminal 52, communicate the information to the transaction processing facility 102, as shown by arrow 106. The consumer information may then be processed at the transaction processing facility 102 in order to generate a list of approved payment method options, which are then communicated to the merchant 50. The list of approved payment method options may then be presented to the consumer via the user terminal 52. The consumer may then be requested to select a payment option among the approved payment options. If the consumer wishes to select an option that has not been approved due, for example, to insufficient consumer information, the merchant 50 may solicit additional information from the consumer 52 in order for the transaction processing facility 102 to validate the selected option.

In one exemplary embodiment, the transaction processing facility 102 may utilize the payment options rules engine 80, as well as validation facilities 54, 58, 60, and 62. In one embodiment of the invention, the transaction processing facility 102 utilizes other sources of information or facilities 63; such other sources of information may include, for example, information from credit bureaus and BNA providers, to perform additional validations, as shown by arrow 110.

In one exemplary embodiment of the present invention, the transaction processing facility 102 investigates an appropriate facility (e.g., the telephone bill validation facility 56) via its transaction processing equipment 44. The transaction processing equipment 44 communicates validation data, including a list of approved payment options for the consumer, as shown by arrow 112, to the merchant network equipment 42 of the merchant 50. The merchant network equipment 42 may then communicate an appropriate response to the user terminal 52 as shown by arrow 104. The user may then be presented an option to select one of the approved payment options.

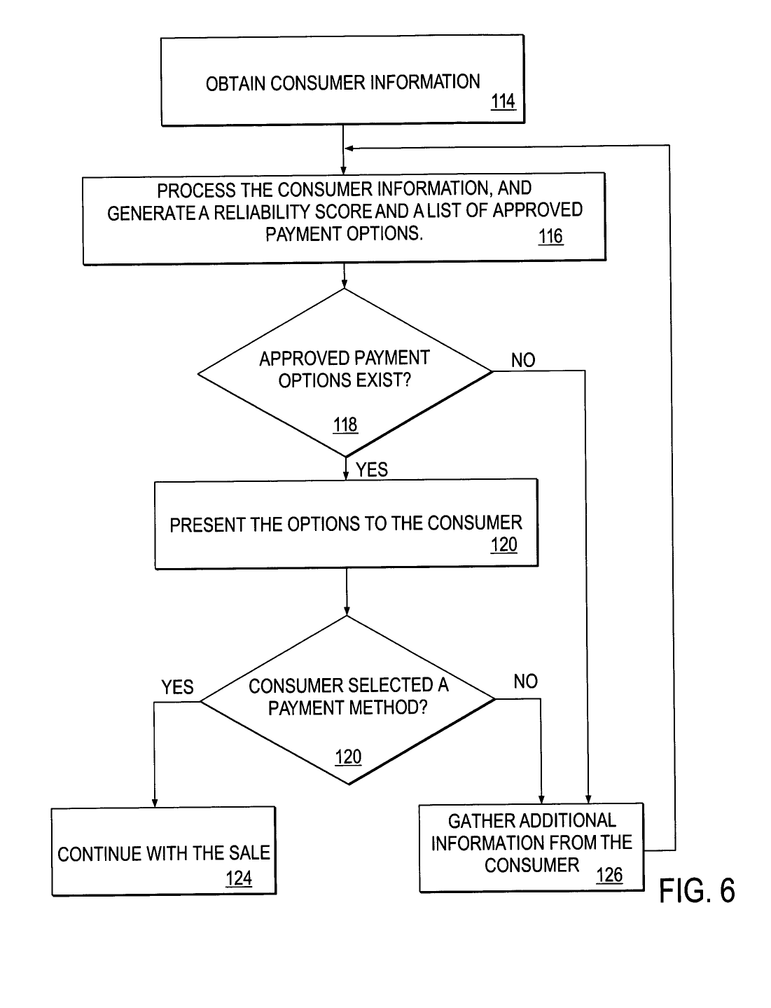

FIG. 6 is schematic operational flow diagram of a method to present approved payment options, according to one embodiment of the present invention. The consumer information is obtained at operation 114. The consumer information is then processed, and the reliability score is generated at operation 116. If it is determined at the decision operation 118 that at least one approved payment option or method exists, at least one approved payment option is presented to the consumer at operation 120. If one or more payment options are presented, and if the consumer makes a selection of one of the approved payment options (see operation 120), the merchant may continue with the user transaction (e.g. sale) at operation 124. In one embodiment, if the consumer wishes to select a payment method that does not appear on the approved payment methods list presented to the user, the consumer may select an appropriate indicator or button and, in response thereto, the merchant may request additional information from the consumer at operation 126. This additional information may be more intrusive (e.g., a social security number, or a credit card number), and may be used to generate a new list of approved payment methods.

The invention may extend to a scenario where a transaction (e.g., a sale) is effectuated via the Internet (e.g., utilizing web services in the form of an on-line store). Furthermore, the present invention may also extend to a scenario where the approved payment method list is generated following a verbal or written communication from a purchaser.

FIG. 7 illustrates exemplary operations performed where a user selects a payment option before the user is presented with the list of approved options. The latter scenario may take place at a convenience store where a user (in this case, a customer or consumer) wishes to pay for a product, for example soft drink, via his or her telephone bill. The merchant obtains the customer selection, which in turn is obtained by the transaction processing facility 102 at operation 132. The merchant (in this example, a store clerk) may obtain the user's information, including telephone number information, enter the information into a computer to communicate it to the transaction processing facility 102. The customer's information is then received by the transaction processing facility 102 at operation 134. The transaction processing facility 102 may then process the customer's information and generate a reliability score for the customer at operation 136. The payment method selected by the customer is then validated utilizing the reliability score value at operation 138. If there are other approved payment options available for the customer, such other approved payment options are identified utilizing the reliability score value at operation 140. The merchant may then receive the validation information regarding the telephone bill payment option as well as the list of all of the other approved payment options. The list of approved payment options is presented to the customer at operation 142. If the telephone bill payment option is approved at operation 144, the merchant may continue with the sale transaction at operation 146. If the telephone bill payment option is not approved at operation 144, in one embodiment, alternative payment options may be presented to the customer at operation 148, and the customer may select an alternative payment method at operation 150. As the payment alternatives or options have already been validated, the merchant does not need to validate an alternative option selected by the customer from the list of approved payment options. Thus, the present invention may be practiced where an intermediary (e.g., a store clerk) is receiving data from an end user (e.g., a purchaser) and communicating the data to the transaction processing facility 102 of a network-based commerce facility. It is, however, to be appreciated that the same or any other payment options may be rechecked (e.g., checking an ACH or credit card balance).

Thus, in one embodiment, the method and system uses identification data or information that identifies a user or consumer to generate various different payment options that are presented to the user. The options may be presented to the user are typically options that are considered to be valid or allowable for the specific user. In one embodiment, all valid options may be presented to the user simultaneously. In addition or instead, the valid payment options may be sequentially or serially presented to the user. For example, if a payment option selected by the user fails (e.g. because of vendor criteria, the user having a poor payment history for the particular option, or the like), the system and method may then generate another valid payment option for the particular user. Accordingly, in one embodiment, the system and method may in advance “predict” what options to present to the user or purchaser (e.g., based on the vendor and consumer or any other criteria in the payment option rules engine). However, the system and method may also “dynamically” provide payment options to the user during the transaction process, for example, if a selected payment option fails.

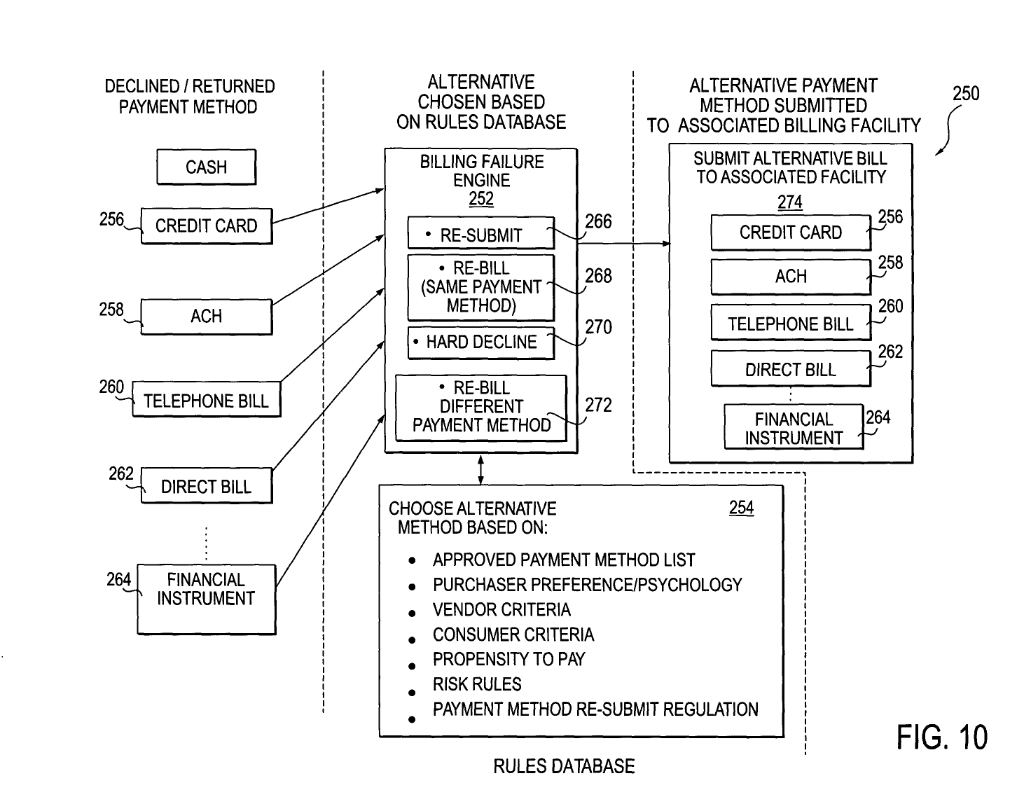

Referring in particular to FIG. 10, reference numeral 250 generally indicates a functional diagram of a system, in accordance with the invention, to process a billing failure in a network-based commerce system. The system 250 may, for example, form part of the transaction processing system 40 as described above. Thus, in one embodiment, the system 250 may be used to process a billing failure where a user has a plurality of different payment methods approved for payment while conducting transactions via the network-based commerce system.

The system 250, in the exemplary embodiment, includes a billing failure engine 252 that receives a billing failure indicator from a billing facility (e.g. a bank 32 or telephone company 253) that indicates that a specific billing transaction submitted to the billing facility was unable to be billed. In certain embodiments, the billing failure is processed by the billing failure engine 252 using a plurality of billing failure rules 254. As described in more detail below, the billing failure rules 254 may be dependent upon user or consumer criteria, merchant criteria, the particular billing method that failed, or the like. In one embodiment, the billing failure rules 254 may be similar to the rules for generating payment method options as described above.

The billing failure engine 252 may, for example, receive a billing failure record from a credit card facility 256, an ACH facility 258, a telephone service provider facility 260, a direct bill facility 262, or any other financial instrument processing facility 264.

The billing failure engine 252 may perform any one of a plurality of functions when it receives a billing failure indicator from any one of the facilities 256 to 264. For example, the billing failure engine 252 may re-submit the billing transaction to an associated billing facility (see block 266), re-bill the purchase transaction using the same payment or transaction processing method (see block 268), hard decline (e.g. not provide the products requested by the user in the transaction) as shown at block 270, or may re-bill the purchase transaction using a different transaction processing or payment method as shown at block 272. When the billing failure engine 252 (which may be provided at a transaction processing facility) re-bills the purchase transaction to a different payment method, then a new billing transaction may be communicated to an associated billing facility 274. Thus, for example, if the purchase or user transaction was initially concluded using the ACH payment method, and the billing failure indicator is then received from an ACH facility 258, the billing failure engine 252 may, based on the billing failure rules 254, generate an alternative payment method selected from any one of a number of authorized alternative payment methods uniquely associated with the user. The alternative payment method may then be communicated to the appropriate facility, for example, the credit card facility 256, the telephone service provider 260, the direct bill service provider facility 262, or the financial instrument facility 264 as the case may be. Thus, when a particular payment method or financial instrument fails, the billing failure engine 252 generates alternative payment methods and, in an automated fashion without human intervention, automatically re-bills the particular purchase transaction to a different or alternative payment method or payment instrument.

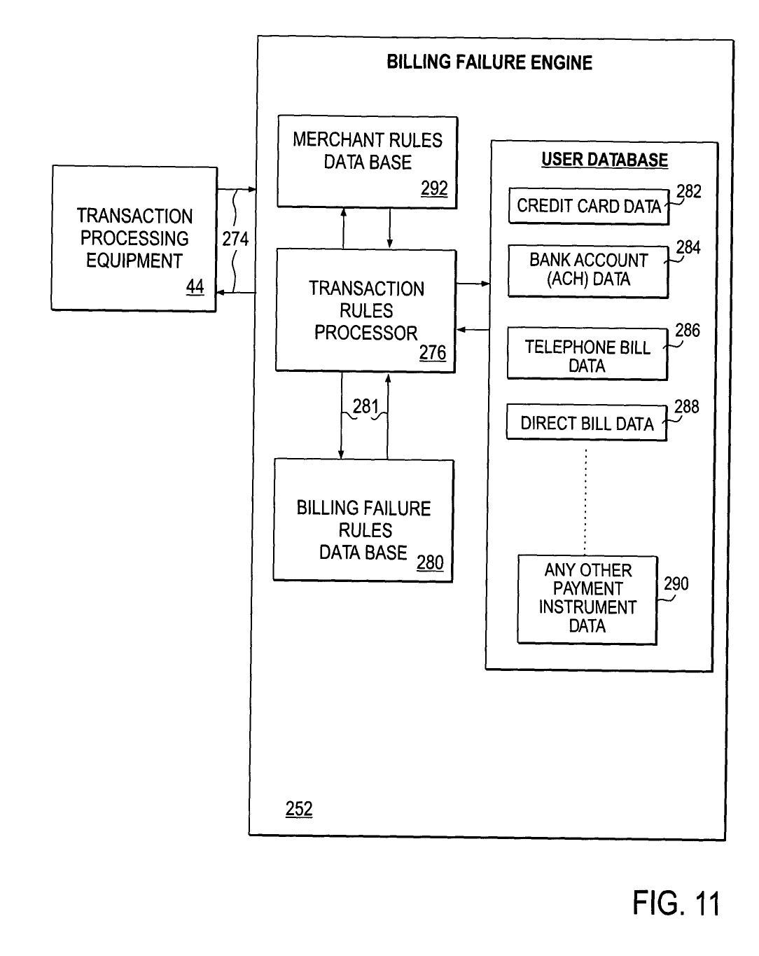

Referring in particular to FIG. 11, reference numeral 252 generally indicates an exemplary embodiment of a billing failure engine in accordance with one embodiment of the invention. The billing failure engine 252 may form a separate unit and communicate via dedicated communication lines 274 with the transaction processing equipment 44 (see FIG. 2). In other embodiments, the billing failure engine 252 may form part of the transaction processing equipment 44. Accordingly, the billing failure engine 252 may either communicate directly or remotely with the transaction processing equipment 44.

The billing failure engine 252 includes a transaction rules processor 276 that communicates with a billing failure rules database 280 via communication lines 281. The billing failure rules database 280 may substantially resemble the billing failure rules database 254 and, it will be appreciated, that various different rules may be chosen by a processing facility using the billing failure engine 252. Thus, in one embodiment, the billing failure rules database 280 may be customized to a particular application and to the various payment methods or payment instruments that the billing failure engine is configured to process.

The transaction rules processor 276 also communicates with a user database 278 wherein user rules or customer rules may be provided. The user database 278 may include, for each particular user of the network-based commerce system, credit card data 282, bank account (ACH) data 284, telephone bill data 286, direct bill data 288, or any other payment instrument data 290. In addition, the billing failure engine 252 may include a merchant rules database 292. Any one or more of the components of the billing failure engine 252 may be distributed across one or more servers that may or may not be located at the same geographic location. In certain embodiments, the billing failure rules database 280 may include data from the merchant rules database 292 and the user database 278. In one embodiment, the user database 278 may store the various payment method options provided to the user as discussed above.

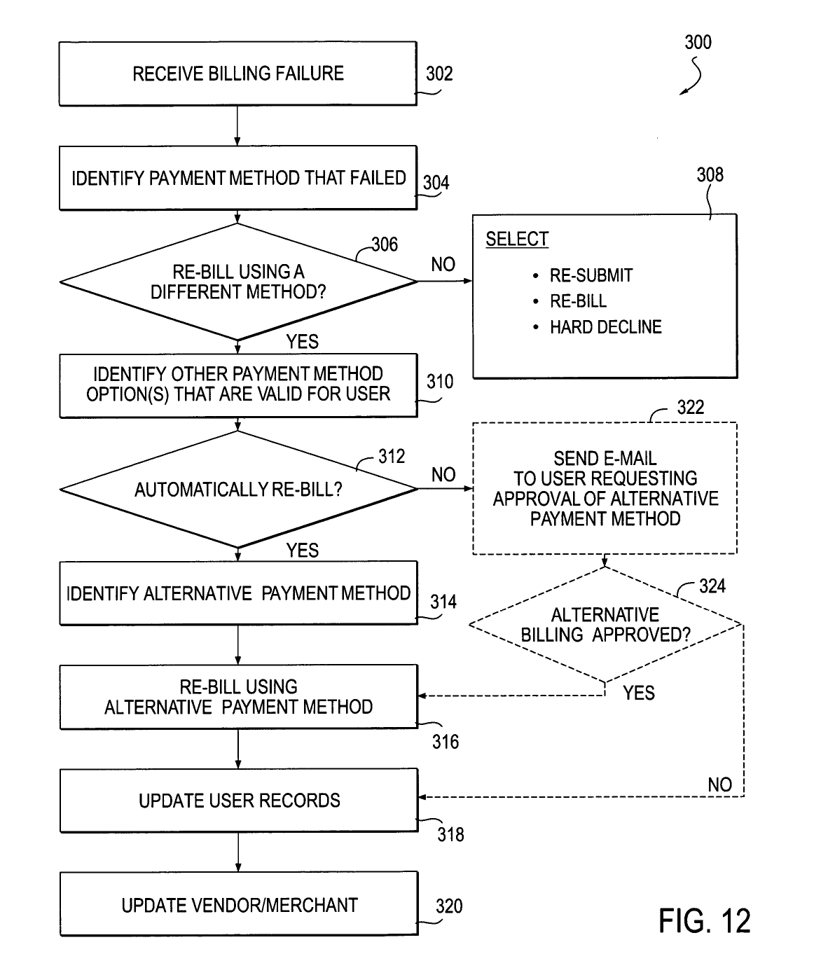

Reference numeral 300 (see FIG. 12) generally indicates a method, in accordance with the invention, to process billing failures in a network-based commerce system. The method 300 initially receives a billing failure as shown at operation 302. The billing failure may relate to a transaction that has been concluded between a user or customer and a merchant (as described above). Although the transaction between the user and the merchant may have initially been authorized or validated, circumstances may arise in which the billing transaction that is subsequently presented to the billing facility it is declined or disapproved. Accordingly, in these circumstances, unless the billing failure is attended to, the merchant and or transaction processing facility may not receive payment for the products purchased by the user. In certain circumstances, the products may already have been provided to the user. For example, when a user orders digital content online, the digital content is typically immediately streamed to the user. In other circumstances, physical goods may already have been dispatched and delivered to the user. Accordingly, it is advantageous for a merchant to have alternative billing methods in order to secure payment for the products.

Returning to FIG. 12, when the billing failure engine 252 receives a billing failure indicator from any one of the billing facilities (e.g. a telephone service provider, a bank, or the like) the billing failure engine 252 identifies the payment method that was selected by the purchaser and that has now subsequently failed (see operation 304). The method 300 then at decision operation 306 identifies the manner in which it is to process the billing failure. In particular, the method 300 identifies whether or not the purchase transaction should be billed using a different billing method and, if not, then the method 300 proceeds to operation 308. At operation 308 the method 300 may then re-submit the billing transaction to the associated billing facility (e.g. if the payment method was via ACH the method 300 may then re-submit the billing transaction to the ACH in the hope that it will clear the second time), may re-bill the method using the same instrument and re-submit the new billing transaction to the billing facility, or hard decline the transaction. The hard declining of the transaction may only be effective when the products have not already been communicated or delivered to the user.

Returning to decision operation 306, if the method 300 determines that the purchase transaction should be re-billed using a different payment method, then the method 300 identifies other payment method options that are valid for the particular user (see operations 310). For example, as described above, various payment methods or options may initially have been presented to the user at the time the transaction was conducted between the user and the vendor or merchant. However, in other embodiments, a registration process may be provided where a user prior to conducting any transactions via the network-based commerce facility establishes various billing options or payment methods with the transaction processing equipment 44.

Once the alternative payment methods have been determined, the method 300 decision operation 312 determines whether or not the failed billing transaction should be automatically re-billed or not. If the transaction is to be automatically re-billed, then at operation 314 the method 300 identifies an alternative payment method and, using the alternative payment method re-bills the purchase or user transaction as shown at operation 316. Thereafter, user records in the user database 278 are updated (see operation 318) and the vendor or merchant may be optionally informed of the billing failure and/or the new payment method that has been used to bill the transaction (see operation 320).

Returning to decision operation 312, in certain embodiments, the method 300 may optionally send an e-mail to a user requesting approval of the alternative payment method as shown at operation 322. If the user approves billing to the alternative payment method (see operation 324) then the method 300 may proceed to operation 316 where the user is re-billed for the purchase transaction using the alternative payment method. If, however, the user declines billing using the alternative payment method (or provides some other alternative payment method which the user may, or may, not select) then the method proceeds to operation 318 where the user records are updated.

It will be appreciated that the choice of the alternative payment method may be dependent upon user or consumer criteria, vendor criteria, or the like as described above. For example, the choice of the alternative payment method may be based on an approved payment list (generated based on both consumer and vendor criteria), purchaser preference or psychology, vendor and or consumer criteria, a propensity to pay using the alternative payment method, risk rules associated with the selected payment method, rules relating to the resubmission of billing transactions to billing facilities, or the like.

For example, in one embodiment, when a billing failure occurs after a user or consumer has selected billing for a purchase transaction to a telephone service provider account, and the user has subsequently changed his or her telephone number the account can no longer be billed. The billing failure engine 252 may have appropriate rules in the rules database 254 to process such a billing failure. For example, the billing failure engine 252 may then identify a residential address associated with the user (e.g. a delivery address, an address associated with a credit card, ACH details, or the like) and choose as an alternative billing method a direct bill which is mailed to the residential address. It will also be appreciated that a billing failure associated with any one payment method may be re-billed to any other payment method approved for the particular user. Thus, for example, an ACH failure may be alternatively billed to any one of a credit card account, a telephone bill account, a direct bill account, a financial instrument account, or the like. Likewise, a billing failure associated with any one of a credit card, a telephone account, a direct bill account, or a financial instrument may be billed alternatively to an ACH account. Thus, it will be appreciated that any combination of the various accounts may be used when the billing failure engine 252 processes a billing failure to an alternative payment method.

Further, it will be appreciated that not all billing failures are as a result of malicious intent. For example, a user may select to bill a purchase transaction to a telephone account that is associated with a CLEC (Competing Local Exchange Carrier) that the transaction processing facility is unable to bill to. Accordingly, under these circumstances, the billing transaction may fail without any devious intent from the user and the transaction may then be billed using the billing failure engine 252 to an alternative payment method.

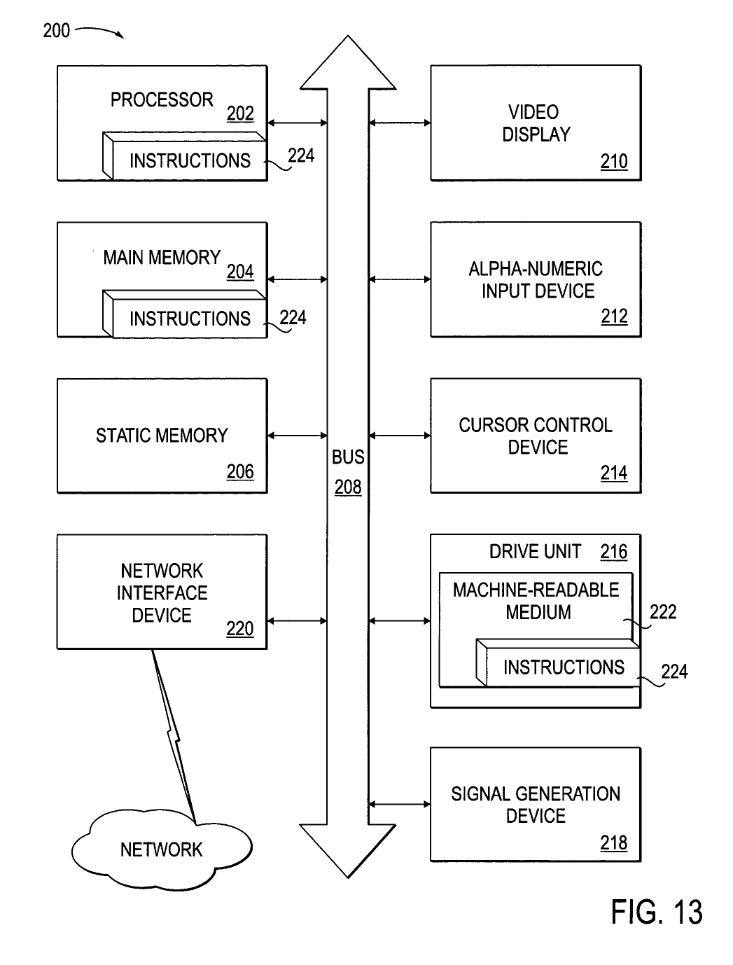

FIG. 13 shows a diagrammatic representation of a machine in the exemplary form of a computer system 200 within which a set of instructions for causing the machine to perform any one of the methodologies discussed above may be executed. In alternative embodiments, the machine may comprise a network router, a network switch, a network bridge, a set-top box (STB), Personal Digital Assistant (PDA), a cellular telephone, a web appliance or any machine capable of executing a set of instructions that specify actions to be taken by that machine.

The computer system 200 includes a processor 202, a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored a set of instructions (software) 224 embodying any one, or all of the methodologies or functions described herein. The software 224 is also shown to reside, completely or at least partially, within the main memory 204 and/or within the processor 202. The software 224 may further be transmitted or received via the network interface device 220. For the purposes of this specification, the term “machine-readable medium” shall be taken to include any medium that is capable of storing, encoding or carrying a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals.

Thus, a method and apparatus to process a billing failure in a network-based commerce facility has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to process a billing failure in a network-based commerce facility, the method including:
receiving a billing failure indicator from a billing facility, the billing failure indicator being associated with a transaction processing method utilized by a user when conducting a user transaction;
automatically without human intervention identifying at least one alternative transaction processing method that is valid for the user; and
automatically communicating the at least one alternative transaction processing method to an associated billing facility for billing.

2. The method of claim 1, which includes retrieving the at least one alternative transaction processing method from a database of predetermined transaction processing methods associated with one of a merchant and a user.

3. The method of claim 1, wherein identifying the at least one alternative transaction processing method includes generating a reliability score value utilizing user information, and selecting a transaction processing method that includes favorable reliability score.

4. The method of claim 1, wherein the at least one alternative transaction processing method is one of a plurality of transaction processing methods presented to the user when the user initially concluded the user transaction.

5. The method of claim 1, which includes:
identifying the at least one alternative transaction processing method from user information associated with the user; and
updating the user information in response to the billing failure for use with future user transactions.

6. The method of claim 1, wherein the plurality of alternative transaction processing methods includes at least one of a credit card option, a phone bill option, an ACH option, a transaction processing by check option, a direct bill option, and a prepayment option.

7. The method of claim 1, wherein identifying the at least one alternative transaction processing method includes identifying a transaction processing method utilizing at least one of vendor criteria, user criteria, type of purchase event criteria, and purchaser payment psychology.

8. The method of claim 1, which includes communicating billing failure data to a merchant with which the user transaction was conducted, the billing failure data identifying the alternative transaction processing method.

9. The method of claim 1, which includes sending an electronic communication to the user indicating that the transaction has been billed using the alternative transaction processing method.

10. The method of claim 1, wherein the alternative transaction processing method is a direct bill, the method including mailing the direct bill to an address that is generated using information associated with the transaction processing method.

11. The method of claim 1, wherein the first transaction processing method and the at least one alternative transaction processing method are payment methods that are pre-authorized by the user.

12. A system to process a billing failure in a network-based commerce facility, the system including:
a communication module to receive a billing failure indicator from a billing facility, the billing failure indicator being associated with a transaction processing method utilized by a user when conducting a user transaction; and
a billing failure engine to automatically without human intervention identify at least one alternative transaction processing method that is valid for the user, the at least one alternative transaction processing method being operatively communicated to an associated billing facility for billing.

13. The system of claim 12, wherein the at least one alternative transaction processing method is retrieved from a database of predetermined transaction processing methods associated with the user.

14. The system of claim 12, wherein identifying the at least one alternative transaction processing method includes generating a reliability score value utilizing user information, and selecting a transaction processing method that includes favorable reliability score.

15. The system of claim 12, wherein the at least one alternative transaction processing method is one of a plurality of transaction processing methods presented to the user when the user initially concluded the user transaction.

16. The system of claim 12, wherein:
the at least one alternative transaction processing method is identified from user information associated with the user; and
the user information is updated in response to the billing failure for use with future user transactions.

17. The system of claim 12, wherein the plurality of alternative transaction processing methods includes at least one of a credit card option, a phone bill option, an ACH option, a payment by check option, a direct bill option, and a prepayment option.

18. The system of claim 12, wherein identifying the at least one alternative transaction processing methods includes identifying a transaction processing method utilizing at least one of vendor criteria, user criteria, type of purchase event criteria, and purchaser payment psychology.

19. The system of claim 12, wherein billing failure data is communicated to a merchant with which the user transaction was conducted, the billing failure data identifying the alternative transaction processing method.

20. A machine-readable medium for embodying a sequence of instructions that, when executed by a machine, cause the machine to:
receive a billing failure indicator from a billing facility, the billing failure indicator being associated with a transaction processing method utilized by a user when conducting a user transaction via a network-based commerce facility; and
automatically without human intervention identify at least one alternative transaction processing method that is valid for the user, the at least one alternative transaction processing method being operatively communicated to an associated billing facility for billing.

21. The machine-readable medium of claim 20, wherein the at least one alternative transaction processing method is retrieved from a database of predetermined transaction processing methods associated with the user.

22. The machine-readable medium of claim 20, wherein identifying the at least one alternative transaction processing method includes generating a reliability score value utilizing user information, and selecting a transaction processing method that includes favorable reliability score.

23. The machine-readable medium of claim 20, wherein the at least one alternative transaction processing method is one of a plurality of transaction processing methods presented to the user when the user initially concluded the user transaction.

24. The machine-readable medium of claim 20, wherein:
the at least one alternative transaction processing method is identified from user information associated with the user; and
the user information is updated in response to the billing failure for use with future user transactions.

25. The machine-readable medium of claim 20, wherein the plurality of alternative transaction processing methods includes at least one of a credit card option, a phone bill option, an ACH option, a payment by check option, a direct bill option, and a prepayment option.

26. The machine-readable medium of claim 20, wherein identifying the at least one alternative transaction processing method includes identifying a transaction processing method utilizing at least one of vendor criteria, user criteria, type of purchase event criteria, and purchaser payment psychology.

27. The machine-readable medium of claim 20, wherein billing failure data is communicated to a merchant with which the user transaction was conducted, the billing failure data identifying the alternative transaction processing method

28. A system to process a billing failure in a network-based commerce facility, the system including:
means to receive a billing failure indicator from a billing facility, the billing failure indicator being associated with a transaction processing method utilized by a user when conducting a user transaction; and
means to automatically without human intervention identify at least one alternative transaction processing method that is valid for the user, the at least one alternative transaction processing method being operatively communicated to an associated billing facility for billing.
